(19) United States
(12) Patent Application Publication
(10) Pub. No.: US 2012/0096035 A1
(43) Pub. Date: Apr. 19, 2012

(54) System and method for conveying offers to a user

(76) Inventor: Donald Spector, New York, NY (US)

(21) Appl. No.: 12/928,616

(22) Filed: Dec. 15, 2010

Related U.S. Application Data
(60) Provisional application No. 61/392,485, filed on Oct. 13, 2010.

(51) Int. Cl. G06F 17/30

(52) U.S. Cl. 707/780; 707/E17.037

(57) ABSTRACT

A system and method of conveying offers to a user in which at least one company is registered in a database on a first computer server and offering software is installed on a computer of the company. The offering software calculates a discount offer to be offered by the company and sends it to the first computer server, via a communication system. The method of the invention also includes installing monitoring software on a second computer server, so that the first computer server can monitor search queries of users received by the second computer server. When a search query sent by a user to the second computer server matches an offer stored on the first computer server, the matching offer is automatically sent to the second computer server via the communication system. This offer is then sent to the user who sent in the matching search query.

### CROSS REFERENCE TO RELATED APPLICATION

Applicant claims priority under 35 U.S.C. 119(e) of U.S. Provisional Patent Application Ser. No. 61/392,485 filed Oct. 13, 2010.

### BACKGROUND OF THE INVENTION

1. Field of the Invention

The present invention relates to a system and method for conveying offers to a user based on a computer search conducted by the user. In particular, the present invention relates to a system and method that provides offers to a user based on a location-based search done by the user, with offers being conveyed based on the search results.

2. The Prior Art

Mobile telephone users often use software to provide information based on the user's location. For example, the services called Poynt® and Where To?® allow a user with a computerized mobile telephone, i.e., a smartphone, to search for businesses and restaurants based on the user's current location, using GPS data from the telephone to generate the list of businesses. Similar systems are used by Opentable® for restaurants, Superpages®, for general directories, GasBuddy® for gas stations, and various others.

While these services are useful, there is no way for a business listed in the list to convey to the user that the particular business may be having a special sale or other discount that might prompt the user to choose that particular business over other businesses on the result list. For example, a particular hotel may be offering its rooms for a 50% discount because it has unsold rooms for that particular evening. It would be beneficial for both the user and the hotel if the hotel could convey this information to the user who just conducted a search for hotels in that particular geographic area.

### SUMMARY OF THE INVENTION

It is therefore an object of the invention to provide a system and method for conveying offers from businesses to users based on the user's geographic location or a location input by the user. This object is accomplished by a system and method of conveying offers to a user in which at least one business is registered in a database on a first computer server, which is operated by the offering system, and offering software is installed on a computer of the business. The offering software calculates a discount offer to be offered by the business and sends it to the first computer server, via a communication system. The method of the invention also includes installing monitoring software on a second computer server, so that the first computer server can monitor search queries of users received by the second computer server. The first computer server is the gateway between the businesses who are looking for customers, and the potential customers, who are searching for businesses through search engines and programs run by the second computer server. When a search query sent by a user to the second computer server matches an offer stored on the first computer server, the matching offer is automatically sent to the second computer server via the communication system. This offer is then sent to the user who sent in the matching search query.

The offer can be sent to the user in a variety of ways. The offer can be posted on a website maintained by the second server, sent by a push notification to the user, or sent via a text message, telephone call or email to the user. A push notification is a technique used by application programs (“apps”) on mobile telephones to alert users to content updates and other events in which the user may be interested. When an event occurs that causes a given app to generate a notification, the notification is pushed to the user by one of three options: sound, onscreen alert, or badge. The advantage to using push notifications over text messages or telephone calls is that the system does not need to identify the user. Push notifications are sent to the operating system provider of the mobile telephone, who also provides the app that the system is operating on, such as Apple®, which then sends the push notification to the subscriber.

Regarding the use of push notifications in the context of the present invention, when a matching coupon or discount offer is located, a push notification is sent to the mobile telephone alerting the user that such an offer exists. The offer can then be retrieved at the website of the system through the app on the mobile telephone.

The offering software can be programmed to automatically calculate the offer based on yield parameters of the business. For example, if the business is a hotel and the hotel happens to have a 50% occupancy rate, it would offer a larger discount than if the occupancy rate were 85%. The offering software takes into account vacancy percentages, such as unreserved tables at restaurants, unreserved hotel rooms or unbooked tour tickets, and evaluates the amount of discount to be offered. Variations of this type of analysis are used in yield management systems of airlines, hotels and rental car companies, automatically calculates their pricing based on availability of seats, rooms or cars.

The offering software can also be programmed to automatically send an offer when the yield parameters exceed a certain amount. In certain circumstances, such as when a hotel, restaurant or tour is almost fully booked, the offering software will not send in any offers, as the company may not be offering discounts at that time. The offering software can be programmed according to the requirements of each individual user, as the parameters can be individually set by each company. The offering software can also set an expiration date and/or time for the offer. This way the offer is only valid for a limited period of time and is removed from the system's computer server upon expiration.

Each company participating in the system pays a fee to the system when an offer is sent or redeemed. In one embodiment, when an offer is redeemed by a user at a business participating in the system according to the invention, the redeemed offer is entered into the offering software of the business and payment instructions are sent by the business to the first computer server. These instructions could include credit card payment information. The credit card information for each business can be stored on the first computer server so that the credit card of the business is automatically charged each time a redeemed offer is entered into the offering software.

In one embodiment, the users access the second computer server via an application program that is accessible by users of a mobile telephone. This app can be a search engine, such as Google®, or a more directed type of directory such as Opentable®, Superpages®, etc.

In another embodiment, the second computer server operates an operating system that is installed on mobile telephones of users. In this embodiment, the operating system could be one such like the Apple® OS operating system installed on the iPhone®, or the Android® operating system. Thus, the provider of the operating system could also function as the provider of offers for any of the search queries received by application programs installed on the user's mobile telephone.

In another embodiment, the second computer server operates a directory that searches databases of other computer servers in response to a search query by a user. This type of directory is similar to the one offered by Poynt®, and Where to?°, as these systems use the data of other programs to provide the offer with search results.

The system of the present invention could also include a bidding system, where only the highest bidder at the time can send an offer to a user. The process would work like this: When the business sends in the offer, the business also sends in a bid indicating the amount that the business would be willing to pay if the offer is accepted. The system then culls the matching offers of the search request sent in by the user, and sends only the offer with the highest bid to the second server for communication to the user. Alternatively, all matching bids can be sent to the user, but can be positioned or allocated in a way such that the highest bidder receives preferential positioning, such as a better location on the website of the second server, or the first push notification, text message, email or phone call.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a block diagram of one embodiment of the system according to the invention;

FIG. 2 shows a block diagram of another embodiment of a system according to the invention;

FIG. 3 shows a sample screen on a user's mobile telephone showing the app of the system according to the invention;

FIG. 4 shows a sample screen of a sample offer page of the app shown in FIG. 3;

FIG. 5 shows a sample push notification with an offer to a user;

FIG. 6 shows a block diagram of the method steps according to the invention;

FIG. 7 shows a block diagram showing additional method steps according to the invention.

### DETAILED DESCRIPTION OF THE PREFERRED EMBODIMENT

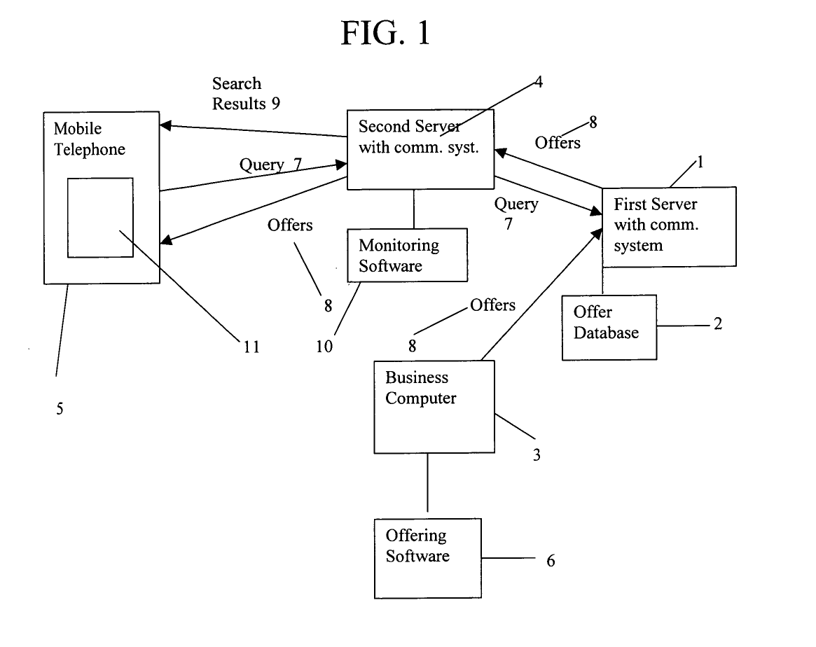

Referring now in detail to the drawings and, in particular, FIG. 1 shows a block diagram of one embodiment of the system according to the invention. The system comprises a computer server 1 having a database 2 that stores offers sent by businesses from business computers 3. The offers are calculated using offering software 6 that can base the amount and timing of the offer using yield management parameters such as those used in the hotel and airline industry. When the offer is calculated by offering software 6, and the yield parameters indicate that the offer should be sent, computer 3 sends the offer 8 via a communication system such as a modem using the internet to first server 1. Server 1 stores offer 8 in an offer database 2.

Server 1 has a communication system which allows server 1 to communicate with other servers, such as second server 4. Second server 4 also has a communication system for communicating with server 1 and various users of the services provided by server 4. In the system according to the invention, the provider of second server 4 registers with the system of server 1 and installs monitoring software 10 on second server 4. Monitoring software 4 allows first server 1 to log into second server 4 and access all queries received by users and search results generated by second server 4.

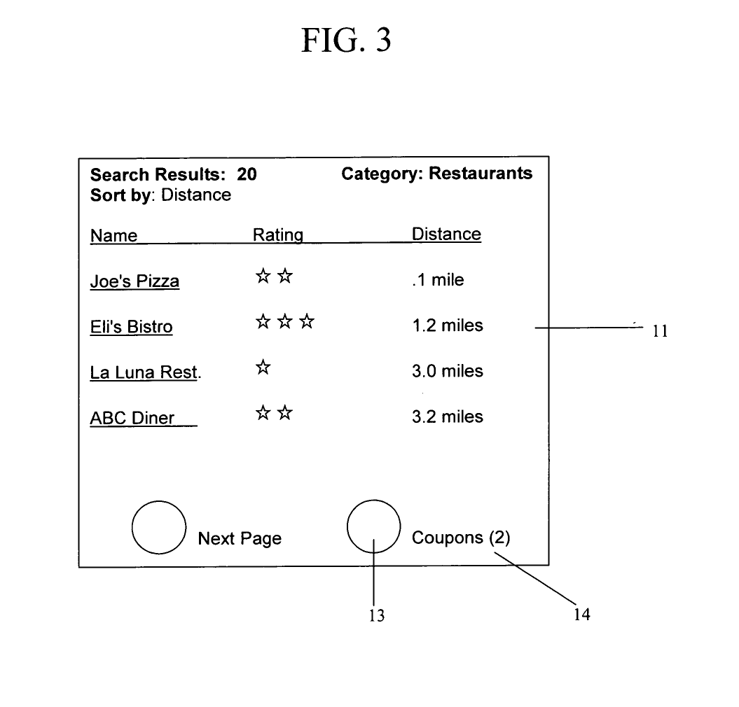

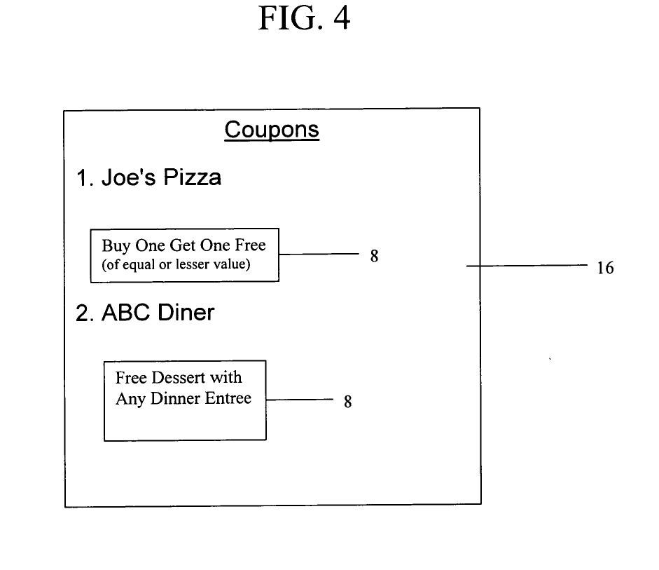

Server 4 could be the server of an operating system of a mobile telephone such as Apple® OS, an application program operated by the operating system, such as Opentable®, or a directory that culls data from other applications to form a universal directory, such as Poynt®. All of these systems use the GPS data of the mobile telephone in their mobile telephone application programs to sort the search results by location of the user and only send search results of businesses within a certain geographic range of the user. Many of these systems also operate non-GPS based programs that allow the user to specify the geographic area during the search query, such as from a desktop computer. Users of mobile telephones or personal computers send these search queries 7 to an application program run by second server 4, which generates a list of results that match the query. These results 9 are sent back to the user's mobile telephone 5 (or personal computer) by posting them on the screen 11 of the app, which is displayed on mobile telephone 5 (or on a personal computer). However, during this search process, the system according to the invention monitors the searches received by second server 4, and if an offer 8 stored in database 2 matches any of the search queries received by second server 4, offer 8 is sent by first server 1's communication system to second server 4 for communication to mobile telephone 5. Offer 8 can be communicated to mobile telephone 5 in a variety of ways. In FIG. 1, offer 8 is posted on the screen 11 of the app operated by second server 4 for display on the mobile telephone, as shown in FIGS. 3 and 4.

FIG. 3 shows search results generated by server 2 in response to query 7 the user. In addition, screen 11 has a Coupon button 13, which when touched, sends the user to a coupon page 16 of the application program, where matching offers 8 are posted, as shown in FIG. 4. Alternatively, offers 8 can be posted directly on the screen 11 listing the search results. This posting can be similar to a banner ad across the top of the screen, a separate column on the screen, or can be embedded in the search results. As a further alternative, the offers can be communicated to the user by email, voice telephone call or text message if server 2 has access to the contact data of mobile telephone 5, or it can be sent by push notification.

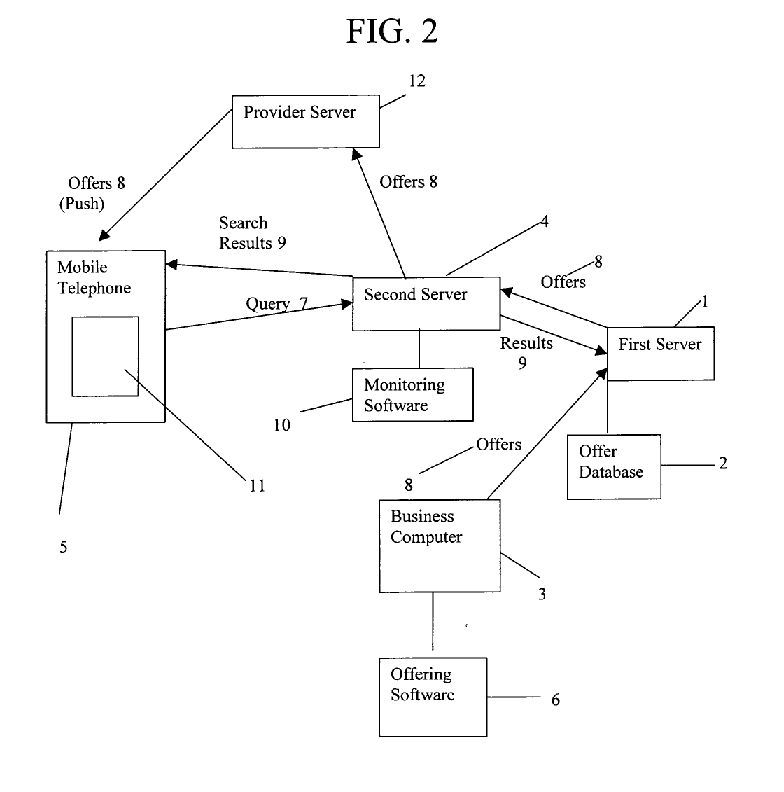

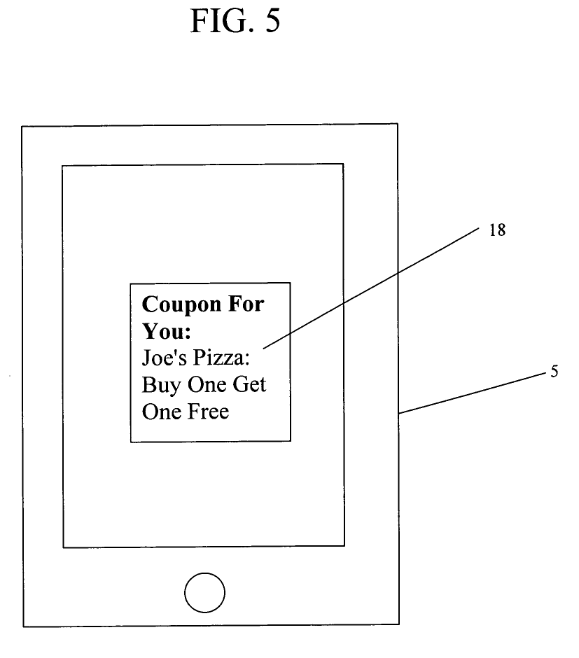

The push notification offer communication system is shown in FIG. 2. Offer 8 is sent to second server 4 in the manner as discussed above with regard to FIG. 1. However, instead of directly communicating the offer to the user, the offer is sent by server 4 to a provider server 12. Provider server 12 operates the operating system of mobile telephone 5 and is able to send push notifications to all of its subscribers. Thus, offer 8 is sent via push notification 18, as shown in FIG. 5 to mobile telephone 5. If second server 4 is the operating system itself, then second server 4 would send the push notification directly from second server 4.

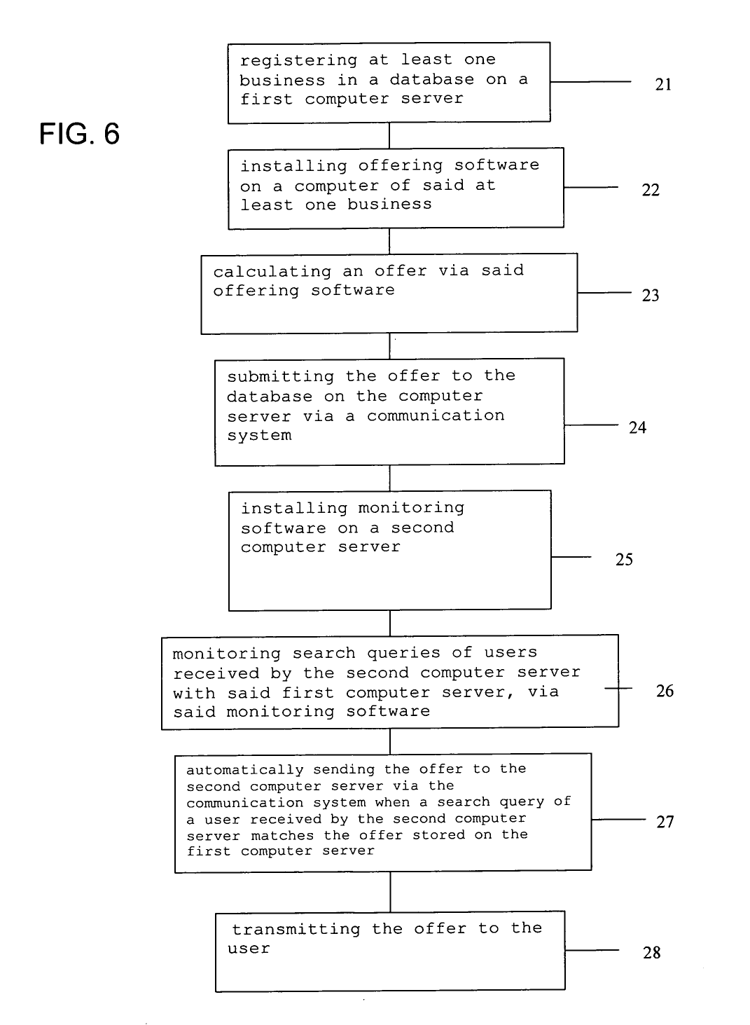

The invention also comprises a method for conveying offers to a user of a mobile telephone, as shown in FIG. 6. The method has the following steps:

At least one business is registered in a database on a first computer server in step 21. Offering software is installed on a computer of the business in step 22. The offering software calculates an offer to be offered by the business in step 23. In step 24, the offer is submitted to the database on the computer server via a communication system. In step 25, monitoring software is installed on a second computer server, and this software allows the first computer server to monitor search queries of users received by the second computer server, in step 26. Then in step 27, the offer is automatically sent to the second computer server from the first computer server when a search query of a user received by the second computer server matches the offer stored on the first computer server. Finally, the offer is transmitted to the user in step 28, by any suitable means, such as posting on the website operated by the second server, sending an email, text or voice message to the user, or by a push notification.

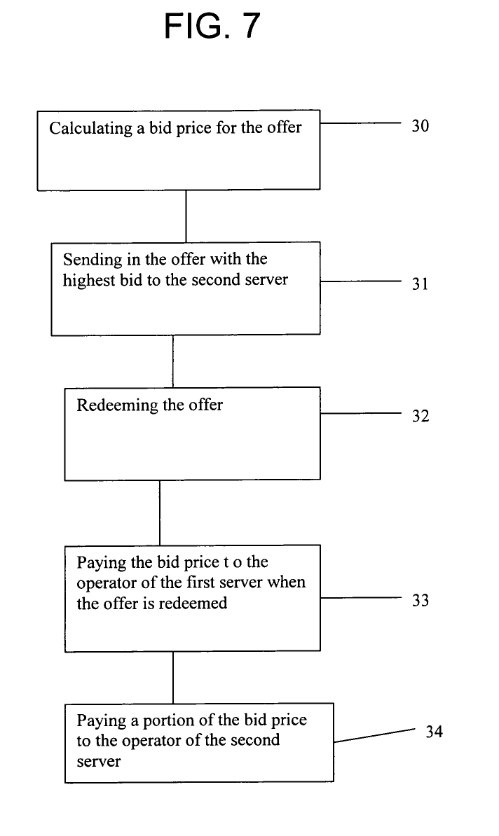

As shown in FIG. 7, the businesses submitting the offers can calculate a bid price 30, i.e., a price that the business is willing to pay for the right to send the offer to a user. This bid can be used by the system operating the first server to choose between multiple competing offers and send the offers in order of bid rank or only send the offer with the highest bid to the second server 31. Once a user redeems the offer, in step 32, by visiting the business and buying the offered goods or services, the business then pays the bid price to the operator of the first server, in step 33. Alternatively, the business can pay the bid price any time an offer is sent by the first server to the second server, regardless of whether it is redeemed. Then, the operator of the first server can pay a portion of this bid price to the operator of the second server in step 34. This way the system operating the application program or operating system generates revenue, as well as the system operating the offering program. This gives the operating systems and application programs incentive to register with the offering program and allow the offers to be sent to users of the operating program or app. Alternatively, the offering system operating the first server could set a price for each offer and then communicate every matching offer to the second server. This price could be a flat fee or could be based on the type of business, such as one rate for hotels, one for restaurants, etc. Any type of pricing system could be used. The individual businesses could also negotiate the price for the offers with the operator of the offering system.

The present invention can provide an ideal opportunity to bring together businesses and customers while generating revenue for the businesses, offering program and search engines or operating systems as well.

Accordingly, while only embodiments of the present invention have been shown and described, it is obvious that many changes and modifications may be made thereunto without departing from the spirit and scope of the invention.

What is claimed is:

1. A system for conveying offers to a user, comprising:
at least one computer with a software program that calculates a discount offer of a business;
a first computer server that stores a database;
a communications system connected from the at least one computer to the first computer server and from the first computer server to a second computer server having a second database that is searchable by a user;
wherein the software program is adapted to send the discount offer via the communication system to the first computer server for storage on said database, and wherein when a search query is received by the second computer server from the user, the first computer server is adapted to access said search query via the communication system and search the database for an offer that matches the search query, and wherein upon finding an offer that matches the search query, the first computer server is adapted to automatically said the offer matching the search query via the communication system to the second computer server for transmission to the user.

2. The system of claim 1, wherein the software program is programmed to automatically send said discount offer to the first computer server based on a set of yield parameters of the business.

3. The system of claim 1, wherein the software program calculates the amount of said offer based on yield parameters of the business.

4. The system of claim 1, wherein the system is adapted to notify the computer when an offer is communicated to the user by the second computer server.

5. The system of claim 1, wherein the first computer server is adapted to receive bids from businesses via the communication system and sort the offers of each business based on the bids submitted by each business, and wherein the system is adapted to automatically supply an offer from the business submitting a highest bid.

6. A method of conveying offers to a user, comprising:
registering at least one business in a database on a first computer server;
installing offering software on a computer of said at least one business;
calculating an offer via said offering software;
submitting the offer to the database on the computer server via a communication system;
installing monitoring software on a second computer server;
monitoring search queries of users received by the second computer server with said first computer server, via said monitoring software;
automatically sending the offer to the second computer server via the communication system when a search query of a user received by the second computer server matches the offer stored on the first computer server; and
transmitting the offer to the user.

7. The method according to claim 6, wherein said step of transmitting the offer comprises at least one of posting the offer on a website maintained by the second server, sending a push notification to the user, sending a text message to the user, sending an email to the user, and placing a telephone call to the user.

8. The method according to claim 6, wherein the offering software automatically calculates the offer based on yield parameters of the business.

9. The method according to claim 6, wherein the offering software automatically sends the offer when the yield parameters exceed a certain amount.

10. The method according to claim 6, further comprising sending payment instructions from the computer to the first computer server after said step of transmitting.

11. The method according to claim 6, further comprising the steps of redeeming the offer at the business and thereafter sending payment instructions from the computer to the first computer server.

12. The method according to claim 6, wherein the second computer server operates an application program that is accessible by users of a mobile telephone.

13. The method according to claim 6, wherein the second computer server operates an operating system that is installed on mobile telephones of users.

14. The method according to claim 6, wherein the second computer server operates a directory that searches databases of other computer servers in response to a search query by a user.

15. The method according to claim 6, wherein the step of submitting an offer also includes submitting a bid with the offer and wherein when more than one offer matches a search query, the first computer server sends the offer with the highest bid to the second computer server.

16. The method according to claim 6, wherein the step of calculating the offer includes calculating a time duration of the offer.
